(19) United States
(12) Patent Application Publication
(10) Pub. No.: US 2007/0188416 A1
(43) Pub. Date: Aug. 16, 2007

(54) Apparatus for driving plasma display panel and plasma display

(75) Inventor: Manabu Inoue, Uji-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/355,104

(22) Filed: Feb. 16, 2006

(51) Int. Cl. G09G 3/28

(52) U.S. Cl. 345/68

(57) ABSTRACT

A PDP driving apparatus drives a plasma display panel (PDP) having sustain electrodes, scan electrodes, and address electrodes. The PDP driving apparatus includes switch elements, and a power source circuit generates a driving voltage of the switch elements. The power source circuit includes a first voltage source, a first capacitor that charges and supplies as the driving voltage an output voltage of the first voltage source, a charging switch element that turns on when a negative electrode of the first capacitor is at a voltage higher than a specified voltage, and a first diode that is connected electrically to the charging switch element and charges the first capacitor with the output voltage of the first voltage source.

### BACKGROUND ART

1. Field of the Invention

The invention relates to a driving apparatus of a plasma display panel (PDP).

2. Related Art

Plasma display is a display device making use of light emitting phenomenon by gas discharge. The display section of the plasma display, that is, a plasma display panel (PDP) is more advantageous than other display devices in the aspect of large screen, thin panel, and wide viewing angle. PDP is roughly classified into DC type operated by direct-current pulses, and AC type operated by alternating-current pulses. The AC type PDP is particularly high in luminance, and simple in structure. Therefore, the AC type PDP is suited to mass production and finer pixel size, and is used in a wide range.

An AC type PDP has, for example, a three-electrode surface discharge structure (see, for example, JP 2005-70787, A). In this structure, address electrodes are disposed on the back surface of PDP in the longitudinal direction, and sustain electrodes and scan electrodes are disposed on the front surface of PDP alternately and in the lateral direction of the panel. The address electrode and scan electrode can be generally controlled for the potential individually one by one.

At the intersection of a pair of mutually adjacent sustain electrode and scan electrode and the address electrode, a discharge cell is formed. On the surface of the discharge cell, a layer made of dielectric (dielectric layer), a layer for protecting electrode and dielectric layer (protective layer), and a layer including phosphor (phosphor layer) are provided. The inside of the discharge cell is filled with gas. When discharge occurs in the discharge cell by application of a pulse voltage to the sustain electrode, scan electrode and address electrode, molecules of the gas are ionized to emit ultraviolet rays. The ultraviolet rays excite the phosphor on the discharge cell surface to generate fluorescence. As a result, the discharge cell emits light.

A PDP driving apparatus generally controls potentials of sustain electrode, scan electrode and address electrode of the PDP according to ADS (address display-period separation) method. The ADS method is one of sub-field methods. In the sub-field method, one field of image is divided into plural sub-fields. A sub-field includes a reset period, an address period, and a sustain period. In the ADS method, in particular, these three periods are set commonly in all discharge cells of the PDP (see, for example, JP2005-70787, A).

In the reset period, a reset pulse voltage is applied between the sustain electrode and scan electrode. As a result, wall charge is made uniform in all discharge cells.

In the address period, a scan pulse voltage is sequentially applied to the scan electrode, and a signal pulse voltage is applied to some of the address electrodes. Herein, the address electrodes to which the signal pulse voltage is applied are selected on the basis of a video signal entered from outside. When a scan pulse voltage is applied to one scan electrode and signal pulse voltage is applied to one address electrode, discharge occurs in the discharge cell positioned at the intersection of such scan electrode and address electrode. By this discharge, the wall charge is accumulated on the discharge cell surface.

In the sustain period, a sustain pulse voltage is applied to all pairs of sustain electrode and scan electrode simultaneously and periodically. At this time, in the discharge cell in which the wall charge is accumulated in address period, discharge by gas continues and luminance occurs. Duration of sustain period varies in each sub-field, and the light emitting time per field of discharge cell, that is, the luminance of discharge cell is adjusted by selection of sub-field to be emitted.

FIG. 8 is a block diagram of scan electrode driving section of a conventional PDP driving apparatus (see, for example, JP 2005-70787, A). A scan electrode driving section 110 includes a scan pulse generating section 111, a reset pulse generating section 112, a first separate switch element QS1, a second separate switch element QS2, and a sustain pulse generating section 113. A PDP 20 is expressed as an equivalent circuit of floating capacity Cp (hereinafter called panel capacity of PDP) between sustain electrode X and scan electrode Y.

The scan pulse generating section 111 includes a first constant voltage source V1, a high side scan switch element Q1Y, and a low side scan switch element Q1Y. The initializing pulse generating section 112 includes a second constant voltage source V2, a high side ramp waveform generating section QR1, a low side ramp waveform generating section QR2, and a third constant voltage source V3. The sustain pulse generating section 113 includes a high side sustain switch element Q7Y, a low side sustain switch element Q8Y, a first recovery diode D1, a second recovery diode D2, a high side recovery switch element Q9Y, a low side recovery switch element Q10Y, a recovery capacitor CY, and a recovery inductor LY.

Thus, the PDP driving apparatus includes various switch elements, and applies specified voltages to the electrodes of the PDP by turning on and off the switch elements. Each switch element is turned on and off by controlling the gate voltage thereof.

For example, as a method of controlling the gate voltage of the high side sustain switch element Q7Y, it is proposed to use a high voltage half bridge driver (M63992FP, manufactured by Mitsubishi Electric Corporation) which is a general-purpose gate driver utilizing charge pump action. When using this general-purpose gate driver, the absolute maximum rating of voltage between the terminal connected to the source of the high side sustain switch element Q7Y and the ground terminal of the general-purpose gate driver is 600 V. Generally, in a PDP driving circuit, the maximum voltage applied to the source of the high side sustain switch element Q7Y is the upper limit of the reset pulse voltage, which is (V1+Vs). At this time, if the upper limit of the reset pulse voltage exceeds 600 V, the general-purpose gate driver is broken down, and thus it is not usable.

For example, when the voltage V3 (>0) of the third voltage source V3 is applied to the PDP, the potential of a sustain pulse transmission path of PDP driving circuit (the path from the output terminal J2Y of the sustain pulse generating section 113 to the source of the low side scan switch element Q2Y) changes from (V1+Vs) to −V3. At this time, the minimum potential of the source of the high side sustain switch element Q7Y is a negative potential, and the general-purpose gate driver is broken down, and it is not usable.

When not using the general-purpose gate driver, for example, it may be proposed to bring the source of the switch element (for example, high side sustain switch element Q7Y) into a completely floating state for driving switch elements. In this case, a capacitor is used for a power source for supplying a power source voltage to the gate driving circuit for driving the gate voltage of the switch element. The positive electrode of the capacitor is connected to a specified gate voltage source by way of a diode, and its negative electrode is connected to the source of the switch element which is to be driven. The capacitor is charged through the diode only in the period of the negative electrode of the capacitor falling to the lowest potential.

For example, the lowest potential appears when the low side ramp waveform generating section QR2 is turned on, and the potential of the sustain pulse transmission path is −V3 and also the source potential of the high side sustain switch element Q7Y is −V3 during the reset period or address period. Only in this period, the capacitor is charged through the diode, in other period, the voltage accumulated in the capacitor is supplied to the gate driving circuit. In this case, to maintain a voltage necessary for the gate driving circuit, a capacitor with large capacity is needed.

That is, when driving the gate of the high side sustain switch element Q7Y, energy of Cin×Vg×Vg×F is needed (Cin is input capacity of the switch element, Vg is a voltage applied to the switch element, and F is number of times of switching operation per second).

Hence, greater energy is required by the gate driving circuit that drives switch elements (for example, high side sustain switch element Q7Y, low side sustain switch element Q8Y, high side recovery switch element Q9Y, low side recovery switch element Q10Y) which are driven in the sustain period in which number of switching operation is large.

In these switch elements, moreover, a large current flows, such as a discharge current by the discharge, or a recovery current by the recovery operation, and thus generally multiple switch elements are connected in parallel. As a result, the input capacity Cin increases. Therefore, to maintain a sufficient voltage in the gate driving circuit, a capacitor with larger capacity is needed, and the mounting area is increased.

Regarding the first and second separate switch elements, although the number of times of switching operation is not so many, a large current flows through them such as discharge current or recovery current. Thus, the first and second separate switch elements include multiple switch elements which are connected in parallel, respectively. Accordingly, the input capacity Cin is also increased. Therefore, to maintain a sufficient voltage in the gate driving circuit, a capacitor of larger capacity is needed, and the mounting area is increased.

In the other method, it may be considered to use an expensive insulation type DC-DC converter, but the number of electronic parts is increased, the mounting area is increased, and a wider area is needed for the substrate.

### SUMMARY OF THE INVENTION

The invention is devised to solve the problems, and hence has an object thereof to present a driving apparatus of a plasma display having a power source circuit capable of supplying a specific voltage stably to switch elements, while suppressing increase of electronic parts and expansion of mounting area.

In a first aspect of the invention, provided is a PDP driving apparatus that drives a plasma display panel having sustain electrodes, scan electrodes, and address electrodes. The PDP driving apparatus includes switch elements, and a power source circuit that generates a driving voltage of the switch elements. The power source circuit includes a first voltage source, a first capacitor that charges and supplies as the driving voltage an output voltage of the first voltage source, a charging switch element that turns on when a negative electrode of the first capacitor is higher than a specified voltage, and a first diode that is connected electrically to the charging switch element and charges the first capacitor with the output voltage of the first voltage source.

In a second aspect of the invention, provided is a plasma display includes a plasma display panel which has sustain electrodes, scan electrodes, and address electrodes, and the PDP driving apparatus that drives the plasma display panel.

In these aspects, the first capacitor may be connected to a sustain switch element, a recovery switch element, and a separate switch element, individually. In this case, the negative electrode of the capacitor may be connected to the source of each switch element. When the source of each switch element is substantially at the same potential, the capacitor may be connected to the source of any one of switch elements.

### EFFECT OF THE INVENTION

In a conventional circuit composed by capacitors and diodes, the capacitor is charged only during a period in which a potential of the source of the switch element is lowest, and the charged voltage is consumed in other period. In this case, a larger energy is required for the gate driving circuit that drives switch elements (for example, a high side sustain switch element, a low side sustain switch element, a high side recovery switch element, and a low side recovery switch element) which operates in the sustain period in which number of switching operations is large, or switch elements (for example, a first separate switch element, and a second separate switch element) having large input capacity entirely because it is used in combination with multiple elements connected in parallel. Therefore a capacitor with large capacity is required for supplying voltages stably, and the mounting area is increased. On the contrary, according to the PDP driving apparatus of the invention, a capacitor with large capacity is not required in the power source circuit, and stable voltages can be supplied while suppressing increase of electronic parts and mounting area.

### BRIEF DESCRIPTION OF DRAWINGS

FIG. 1 is a block diagram of a plasma display in embodiment 1 of the invention.

FIG. 2 is a detailed diagram of a scan electrode driving section in embodiment 1 of the invention.

FIG. 3 is a waveform diagram of an applied voltage to scan electrodes of PDP, and ON periods of switch elements included in scan electrode driving section, in the reset period, address period, and sustain period in embodiment 1 of the invention.

FIG. 4 is a block diagram of a gate driving circuit of a high side sustain switch element in embodiment 1 of the invention.

FIG. 5 is a block diagram of a power source circuit for generating a driving voltage of switch elements in embodiment 1 of the invention.

FIG. 6 shows another example of the power source circuit in embodiment 1 of the invention.

FIG. 7 is a black diagram of the power source circuit for generating driving voltage of switch elements in embodiment 2 of the invention.

FIG. 8 is a block diagram of a scan electrode driving section in prior art.

### DETAIL DESCRIPTION OF PREFERRED EMBODIMENT

Referring now to the drawings, preferred embodiments of the invention are described below.

### Embodiment 1

1.1 Configuration

1.1.1 Plasma Display

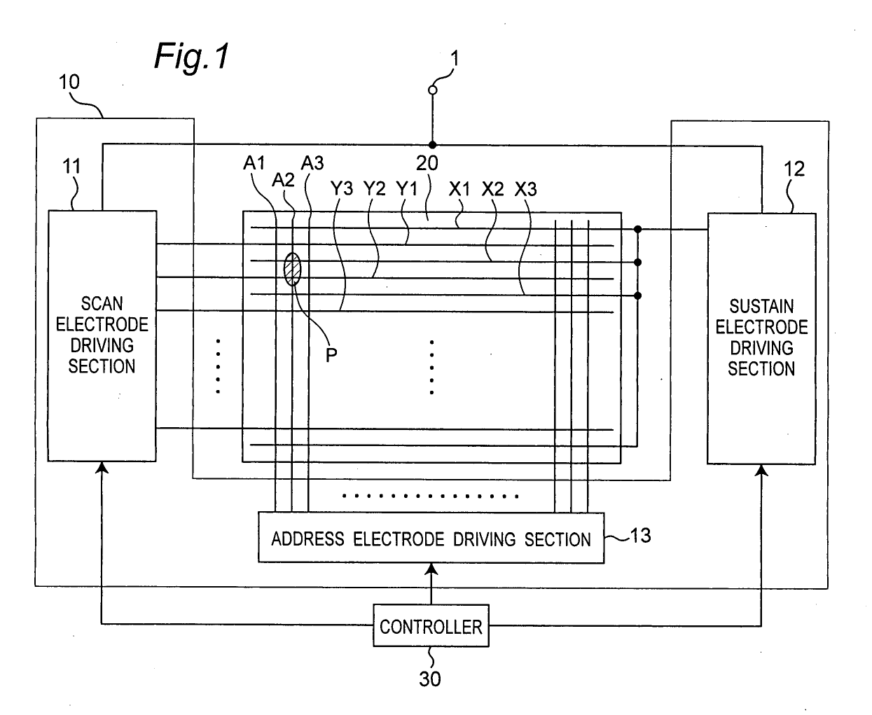

FIG. 1 is a block diagram showing a configuration of a plasma display in an embodiment of the invention. The plasma display includes a PDP driving apparatus 10, a plasma display panel (PDP) 20, and a controller 30.

(Plasma Display Panel)

The PDP 20 is, for example, of AC type, having three-electrode surface discharge type structure. On a back surface of the PDP 20, address electrodes A1, A2, A3, . . . are disposed along the width direction of the panel. On a front surface of the PDP 20, sustain electrodes X1, X2, X3, . . . and scan electrodes Y1, Y2, Y3, . . . are disposed alternately along the longitudinal direction of the panel. The sustain electrodes X1, X2, X3, . . . are mutually coupled to have substantially equal potential. The potentials of address electrodes A1, A2, A3, . . . , and scan electrodes Y1, Y2, Y3, . . . can be controlled individually.

A discharge cell is disposed at an intersection (for example, shaded area P in FIG. 1) of a pair of mutually adjacent sustain electrode and scan electrode (for example, a pair of sustain electrode X2 and scan electrode Y2) and an address electrode (for example, address electrode A2). The surface of the discharge cell includes a layer (dielectric layer) made of dielectric, a layer (protective layer) for protecting the electrodes and dielectric layer, and a layer (phosphor layer) including phosphor. The inside of the discharge cell is filled with gas. Application of a specified voltage to the sustain electrode, scan electrode, and address electrode causes discharge in the discharge cell. At this time, gas molecules in the discharge cell are ionized to emit ultraviolet rays. The ultraviolet rays excite the phosphor on the surface of the discharge cell to generate fluorescence. As a result, the discharge cell emits light.

(PDP Driving Apparatus)

The PDP driving apparatus 10 includes a scan electrode driving section 11, a sustain electrode driving section 12, and an address electrode driving section 13.

An input terminal 1 of the scan electrode driving section 11 and the sustain electrode driving section 12 is connected to a power supply unit (not shown). The power supply unit first converts an alternating-current voltage from an external commercial power source to a specific direct-current voltage (for example, 400V). The direct-current voltage is further converted into a specified direct-current voltage (hereinafter called “sustain voltage”) Vs by a DC-DC converter. The sustain voltage Vs is applied to the PDP driving apparatus 10. As a result, the potential at the input terminal 1 is maintained higher than ground potential (about zero) by the sustain voltage Vs.

Output terminals of the scan electrode driving section 11 are individually connected to scan electrodes Y1, Y2, Y3, . . . of the PDP 20. The scan electrode driving section 11 changes each potential of scan electrodes Y1, Y2, Y3, . . . individually.

Output terminals of the sustain electrode driving section 12 are individually connected to sustain electrodes X1, X2, X3, . . . of the PDP 20. The sustain electrode driving section 12 changes uniformly potentials of sustain electrodes X1, X2, X3, . . . .

The address electrode driving section 13 is connected to address electrodes A1, A2, A3, . . . of the PDP 20 individually. The address electrode driving section 13 generates a signal pulse voltage on the basis of a video signal from outside and applies it to electrodes selected from address electrodes A1, A2, A3, . . . .

The PDP driving apparatus 10 controls the potential of each electrode of the PDP 20 according to the ADS (Address Display-period Separation) method which is one of sub-field methods. For example, in television broadcast in Japan, one field of image is sent at intervals of 1/60 second (about 16.7 msec). Therefore, the display time per field is constant. In the sub-field method, one field is divided into plural sub-fields. Further, in each sub-field, three periods (reset period, address period, and sustain period) are set commonly in all discharge cells of the PDP 20. Duration of the sustain period differs in each sub-field. In the reset period, address period, and sustain period, different pulse voltages are applied to discharge cells as follows.

In the reset period, a reset pulse voltage is applied between the sustain electrodes X1, X2, X3, . . . and scan electrodes Y1, Y2, Y3 . . . . As a result, the wall charges are made uniform in all discharge cells.

In the address period, the scan electrode driving section 11 applies a scan pulse voltage sequentially to the scan electrodes Y1, Y2, Y3, . . . . Simultaneously with application of the scan pulse voltage, the address electrode driving section 13 applies a signal pulse voltage to the address electrodes A1, A2, A3, . . . . Herein, the address electrodes to be applied with the signal pulse voltage are selected on the basis of a video signal entered from outside. Application of a scan pulse voltage to one scan electrode and a signal pulse voltage to one address electrode causes discharge in the discharge cell positioned at the intersection of such scan electrode and address electrode. This discharge causes a wall charge to be accumulated on the discharge cell surface.

In the sustain period, the scan electrode driving section 11 and sustain electrode driving section 12 alternately apply sustain pulse voltages to scan electrodes Y1, Y2, Y3 . . . or sustain electrodes X1, X2, X3, . . . . At this time, the discharge continues to generate emission at the discharge cells which have wall charge accumulated in the address period. Duration of the sustain period varies in each sub-field, and the light emitting time per field of the discharge cell, that is, the luminance of the discharge cell is adjusted by selection of sub-fields to be emitted.

The scan electrode driving section 11, sustain electrode driving section 12, and address electrode driving section 13 individually incorporate switching inverters inside. The controller 30 controls switching of these driving sections. As a result, the reset pulse voltage, scan pulse voltage, signal pulse voltage, and sustain pulse voltage are generated in specified waveform and at specified timing, individually. The controller 30, in particular, selects address electrodes to be applied with signal pulse voltages based on a video signal from outside. Further, the controller 30 determines the duration of the sustain period after application of the signal pulse voltage, that is, the sub-field to which the signal pulse voltage is to be applied. As a result, each discharge cell emits with appropriate luminance. Thus, the video image corresponding to the video signal is reproduced on the PDP 20.

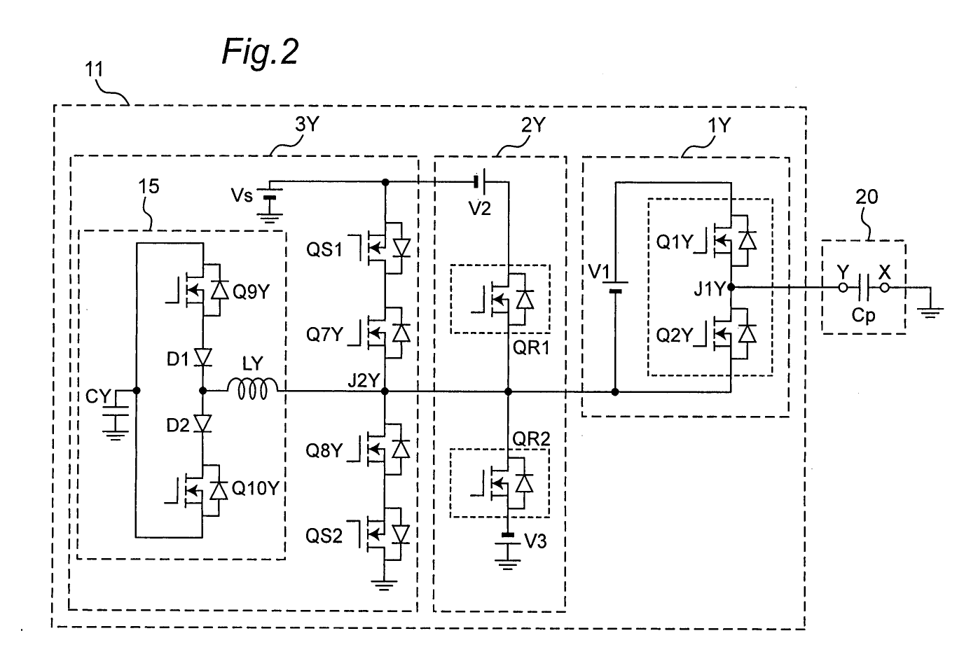

1.1.2 Scan Electrode Driving Section FIG. 2 specifically shows a structure of the scan electrode driving section 11. FIG. 2 also shows an equivalent circuit of the PDP 20. The scan electrode driving section 11 includes a scan pulse generating section 1Y, a reset pulse generating section 2Y, and sustain pulse generating section 3Y. The PDP 20 is equivalently expressed as a floating capacity Cp (PDP panel capacity) between the sustain electrode X and scan electrode Y. A path of a current flowing in the PDP 20 on discharge at the discharge cell is not shown. In FIG. 2, the sustain electrode driving section connected to the sustain electrode X is omitted, and the sustain electrode X is shown as being in grounded state in the diagram.

(Scan Pulse Generating Section)

The scan pulse generating section 1Y includes a first constant voltage source V1, a high side scan switch element Q1Y, and a low side scan switch element Q1Y.

The first constant voltage source V1 maintains the positive potential thereof higher than the negative potential by a specified voltage V1 on the basis of the sustain voltage Vs applied from the power supply unit, using, for example, a DC-DC converter (not shown).

The two scan switch elements Q1Y and Q2Y are, for example, MOS FETs. They may be also IGBTs or bipolar transistors.

The positive electrode of the first constant voltage source V1 is connected to the drain of the high side scan switch element Q1Y. The source of the high side scan switch element Q1Y is connected to the drain of the low side scan switch element Q2Y. The junction JlY of them is connected to one (Y) of scanning electrodes of the PDP 20. The source of the low side scan switch element Q2Y is connected to the negative electrode of the first constant voltage source V1.

Herein, the series connection circuits (portion enclosed by solid line in FIG. 2) of the high side scan switch element Q1Y and low side scan switch element Q2Y are actually provided as many as the number of scan electrodes Y1, Y2, . . . , and are individually connected to the scan electrodes Y1, Y2.

(Reset Pulse Generating Section)

The reset pulse generating section 2Y includes a second constant voltage source V2, a high side lamp waveform generating section QR1, a low side lamp waveform generating section QR2, and a third constant voltage source V3.

The second constant voltage source V2 maintains a potential of the positive electrode higher by a specified voltage V2 with respect to the sustain voltage Vs applied from the power supply unit, using, for example, a DC-DC converter.

The third constant voltage source V3 maintains a potential of the positive electrode higher than a potential of the negative electrode by a specified voltage V3 on the basis of the sustain voltage Vs applied from the power supply unit, using, for example, a DC-DC converter.

The lamp waveform generating sections QR1 and QR2 include, for example, N-channel MOS FET (NMOS). The gate and drain of the NMOS are connected via a capacitor. When the lamp waveform generating sections QR1 and QR2 are turned on, the voltage between the drain and source changes to zero substantially at constant speed.

The positive electrode of the second constant voltage source V2 is connected to the drain of the high side lamp waveform generating section QR1. The source of the high side lamp waveform generating section QR1 is connected to the negative electrode of the first constant voltage source V1. The negative electrode of the second constant voltage source V2 is connected to the positive electrode of the sustain voltage source Vs of the sustain pulse generating section 3Y. The drain of the low side lamp waveform generating section QR2 is connected to the negative electrode of the first constant voltage source V1, and the source of the low side lamp waveform generating section QR2 is connected to the negative electrode of the third constant voltage source V3. The positive electrode of the third constant voltage source V3 is grounded.

(Sustain Pulse Generating Section)

The sustain pulse generating section 3Y includes a high side sustain switch element Q7Y, a low side sustain switch element Q8Y, a first separate switch element QS1, a second separate switch element QS2, and a recovery switch 15. The recovery switch 15 includes a first recovery diode D1, a second recovery diode D2, a high side recovery switch element Q9Y, a low side recovery switch element Q10Y, a recovery capacitor CY, and a recovery inductor LY.

Two sustain switch elements Q7Y, Q8Y and two recovery switch elements Q9Y, Q10Y are, for example, MOSFETs. Besides, IGBTs or bipolar transistors may be used.

The sustain voltage source Vs sustains the potential of the positive electrode higher than the potential of the negative electrode by a specific voltage Vs (sustain voltage).

A junction J2Y between the high side sustain switch element Q7Y and the low side sustain switch element Q8Y is connected to the negative electrode of the first constant voltage source V1, as an output terminal of the sustain pulse generating section 3Y. The path from the output terminal J2Y of the sustain pulse generating section 3Y to the anode of the low side scan switch element Q2Y is hereinafter called “sustain pulse transmission path.”

The source of the first separate switch element QS1 is connected to the positive electrode of the sustain voltage source Vs, and the drain of the first separate switch element QS1 is connected to the drain of the high side sustain switch element Q7Y. The source of the high side sustain switch element Q7Y is connected to the drain of the low side sustain switch element Q8Y. The source of the low side sustain switch element Q8Y is connected to the source of the second separate switch element QS2. The drain of the second separate switch element QS2 is connected to the negative electrode of the sustain voltage source Vs. The negative electrode of the sustain voltage source Vs is, for example, 0 V (grounded state).

The first separate switch element QS1 may be connected between the high side sustain switch element Q7Y and the junction J2Y. The second separate switch element QS2 may be connected between the low side sustain switch element Q8Y and the junction J2Y.

The source of the high side recovery switch element Q9Y is connected to the anode of the first recovery diode D1, the cathode of first recovery diode D1 is connected to the anode of the second recovery diode D2, and the cathode of the second recovery diode D2 is connected to the drain of the low side recovery switch element Q10Y. One end of the recovery inductor LY is connected to the junction J2Y, and the other end is connected to the cathode of the first recovery diode D1. One end of the recovery capacitor CY is connected to the negative electrode of the sustain voltage source Vs, and the other end is connected to the drain of the high side recovery switch element Q9Y and the source of the low side recovery switch element Q10Y.

The capacity of the recovery capacitor CY is sufficiently larger than the panel capacity Cp of the PDP 20. The voltage across the recovery capacitor CY is maintained substantially same as a half (Vs/2) of the sustain voltage Vs applied from the power supply unit.

1.2 Operation

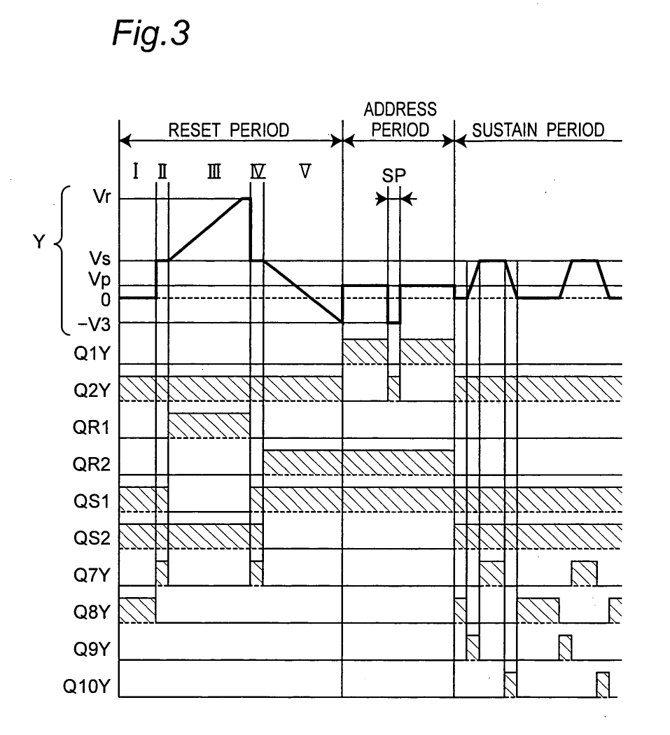

FIG. 3 is a waveform diagram of an applied voltage to scan electrodes Y of PDP 20, and ON periods of switch elements Q1Y, Q2Y, QS1, QS2, Q7Y to Q10Y included in the scan electrode driving section 11, in the reset period, address period, and sustain period. In FIG. 3, ON periods of switch elements are shown in shaded area. Operation in each period is explained below.

1.2.1 Reset Period

Depending on changes of the reset pulse voltage, the reset period is divided into the following five modes I to V.

<Mode I>

In the scan electrode driving section 11, the first separate switch element QS1, second separate switch element QS2, low side scan switch element Q2Y, and low side sustain switch element Q8Y are kept in ON state (other switch elements are kept in OFF state). As a result, the scan electrode Y is maintained at grounding potential (about 0).

<Mode II>

In the scan electrode driving section 11, the low side scan switch element Q2Y, first separate switch element QS1, and second separate switch element QS2 are kept in ON state, while the low side sustain switch element Q8Y is turned off, and the high side sustain switch Q7Y is turned on (other switch elements are held in OFF state). As a result, the potential of the scan electrode Y is raised to a potential Vs which is higher than the grounding potential (about 0) by the sustain voltage Vs.

<Mode III>

In the scan electrode driving section 11, the low side scan switch element Q2Y and second separate switch element QS2 are kept in ON state, while the first separate switch QS1 and high side sustain switch element Q7Y are turned off, and the high side ramp waveform generating section QR1 is turned on (other switch elements are held in OFF state). As a result, the potential of the scan electrode Y is raised to a potential Vr (hereinafter called “upper limit of reset pulse voltage”) which is higher than the grounding potential (about 0) by the sum of the sustain voltage Vs and the voltage V2.

Thus, for all discharge cells of PDP 20, the applied voltage is raised uniformly and relatively slowly up to the upper limit Vr of the reset pulse voltage. As a result, in all discharge cells of PDP 20, a uniform wall voltage is accumulated. At this time, since elevating speed of the applied voltage is small, light emission of discharge cells is kept to a very dim light.

<Mode IV>

In the scan electrode driving section 11, the low side scan switch element Q2Y and second separate switch element QS2 are kept in ON state, while the high side ramp waveform generating section QR1 is turned off, and the first separate switch element QS1 and high side sustain switch element Q7Y are turned on (other switch elements are held in OFF state). As a result, the potential of the scan electrode Y is lowered to a potential Vs.

<Mode V>

In the scan electrode driving section 11, the low side scan switch element Q2Y and first separate switch element QS1 are kept in ON state, while the second separate switch element QS2 and high side sustain switch element Q7Y are turned off, and the low side ramp waveform generating section QR2 is turned on (other switch elements are held in OFF state). As a result, the potential of the scan electrode Y is lowered to a potential −3V which is lower than the grounding potential (about 0) by the voltage V3. Therefore, in mode V, a voltage with reverse polarity of the applied voltage in modes II to IV is applied to discharge cells of PDP 20. In particular, the applied voltage descends relatively slowly. As a result, in all discharge cells, the wall charges are uniformly removed and made uniform. At this time, since the descending speed of the applied voltage is small, light emission of discharge cells is kept to a dim light.

1.2.2 Address Period

During the address period, in the scan electrode driving section 11, the low side ramp waveform generating section QR2 and first separate switch element QS1 are maintained in ON state. Therefore, the drain of the high side scan switch element Q1Y is maintained at a potential Vp (hereinafter called “upper limit of the scan pulse voltage”) higher than the potential −V3 by the voltage V1, while the source of the low side scan switch Q2Y is maintained at −V3.

Upon start of the address period, for all scan electrodes Y, the high side scan switch element Q1Y is maintained in ON state, and the low side scan switch element Q2Y is maintained in OFF state. As a result, the potential of all scan electrodes Y is uniformly maintained at the upper limit Vp of the scan pulse voltage.

Successively, the scan electrode driving section 11 changes the potential of the scan electrode Y as follows (see the scan pulse voltage SP shown in FIG. 3). When one scan electrode Y is selected, the high side scan switch element Q1Y connected to this scan electrode Y is turned off, and the low side scan switch element Q2Y connected to this scan electrode Y is turned on. As a result, the potential of this scan electrode Y is lowered to −V3. The potential of this scan electrode Y is maintained at −V3 for a specified time, and then the low side scan switch element Q2Y connected to this scan electrode Y is turned off, and the high side scan switch element Q1Y connected to this scan electrode Y is turned on. Consequently, the potential of the scan electrode Y is elevated up to the upper limit Vp of the scan pulse voltage. Similarly, the scan electrode driving section 11 switches sequentially the scan switch elements Q1Y and Q2Y connected to each of the scan electrodes. Thus, the scan pulse voltage SP is sequentially applied to the scan electrodes.

During the address period, when one address electrode A is selected on the basis of the video signal entered from outside, the potential of the selected address electrode A is elevated to the upper limit Va of the signal pulse voltage for a specified time (not shown).

For example, when the scan pulse voltage SP is applied to one scan electrode Y and the signal pulse voltage is applied to one address electrode A, a voltage between the scan electrode Y and address electrode A is higher than a voltage between other electrodes. Therefore, the discharge occurs in the discharge cell positioned at the intersection of the scan electrode Y and the address electrode A. This discharge causes a new wall charge to be accumulated on the discharge cell surface.

Afterwards, in the sustain period, the scan electrode driving section 11 and sustain electrode driving section 12 (not shown) alternately apply sustain pulse voltages to the scan electrode Y and sustain electrode X (see FIG. 3). At this time, the discharge continues in the discharge cell in which the wall charge is accumulated during the address period, and hence light is emitted.

1.2.3 Sustain Period

The sustain period is explained below. During the sustain period, the first separate switch element QS1, second separate switch element QS2, and low side scan switch element Q2Y are always kept in ON state.

Just before the high side recovery switch Q9Y is turned on, the low side sustain switch element Q8Y has been turned on, and the voltage across the panel capacity Cp is kept at 0 V. When the high side recovery switch element Q9Y is turned on, an LC resonance circuit is formed by the recovery capacitor CY, high side recovery switch element Q9Y, first recovery diode D1, recovery inductor LY and panel capacity Cp, and the voltage across the panel capacity Cp is increased up to Vs (other switch elements are kept in OFF state).

Then, the high side recovery switch element Q9Y is turned off, and the high side sustain switch element Q7Y is turned on, and a voltage across the panel capacity Cp is maintained at Vs. At this time, a voltage between the drain and source of the high side sustain switch element Q7Y is zero, thus resulting in turn-on of switch with almost no loss (the other switch elements are maintained in OFF state).

After a specified time, the high side sustain switch element Q7Y is turned off, and the low side recovery switch element Q10Y is turned on. Then an LC resonance circuit is formed by the recovery capacitor CY, low side recovery switch element Q10Y, second recovery diode D2, recovery inductor LY and panel capacity Cp. The voltage across the panel capacity Cp is decreased to 0 (other switch elements are kept in OFF state).

When the low side recovery switch element Q10Y is turned off and the low side sustain switch element Q8Y is turned on, the voltage across the panel capacity Cp is maintained at OV. At this time, since the voltage between drain and source of the low side sustain switch element Q8Y is zero, turn-on of the switch can be achieved with almost no loss (the other switch elements are maintained in OFF state).

When the potential of the scan electrode Y rises or falls, electric power is efficiently exchanged between the recovery capacitor CY and panel capacity Cp. Thus, during application of the sustain pulse voltage, reactive power due to charge or discharge of the panel capacity is decreased.

1.3 Gate Driving Circuit

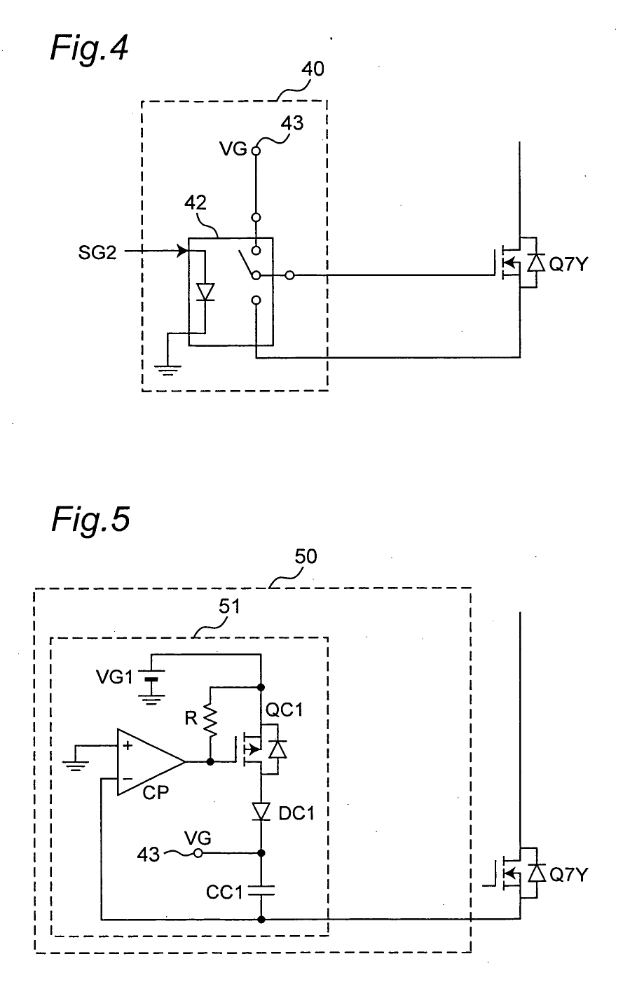

FIG. 4 is a block diagram of a gate driving circuit for driving the gate of the switch element. FIG. 4 shows a structure for driving the gate of the high side sustain switch element Q7Y. However, this structure can be also applied to the low side sustain switch element Q8Y, the high side recovery switch element Q9Y, the low side recovery switch element Q10Y, the first separate switch element QS1, or the second separate switch element QS2.

In FIG. 4, the gate driving circuit 40 includes a gate signal circuit 42 and a power source output terminal 43. A driving voltage VG is supplied to the power source output terminal 43 from the power source circuit. Detail of the power source circuit is described later.

The gate signal circuit 42 have a photo coupler in its inside. A control signal SG2 for controlling the high side sustain switch element Q7Y from the controller 30 is connected to the anode of the internal photo coupler, and the cathode of the internal photo coupler is grounded. The power source terminal for supplying electric power to the gate signal circuit 42 is connected to the power source output terminal 43. The ground terminal of the gate signal circuit 42 is connected to the source of the high side sustain switch element Q7Y. The output of the gate signal circuit 42 is connected to the gate of the high side sustain switch element Q7Y.

When the control signal SG2 from the controller 30 becomes “H”, the gate signal circuit 42 applies a voltage higher than the source potential of the high side sustain switch element Q7Y by the voltage applied to the power source output terminal 43, to the gate of the high side sustain switch element Q7Y. As a result, the high side sustain switch element Q7Y is turned on.

When the control signal SG2 from the controller 30 becomes “L”, the gate signal circuit 42 applies the source potential of the high side sustain switch element Q7Y to the gate of the high side sustain switch element Q7Y. As a result, the high side sustain switch element Q7Y is turned off.

In this embodiment, the gate signal circuit 42 incorporates the photo coupler, but it may not incorporate the photo coupler. In such a case, the photo coupler and gate signal circuit 42 are provided separately.

Thus, the control signal is amplified by the gate driving circuit 40 and applied to the gate of the high side sustain switch element Q7Y to drive the high side sustain switch element Q7Y.

1.4 Power Source Circuit

1.4.1 Configuration of Power Source Circuit

FIG. 5 shows a power source circuit 50 for generating a driving voltage VG and supplying it to the gate driving circuit. The power source circuit 50 includes a first power source circuit 51. FIG. 5 shows an example applied to the high side sustain switch element Q7Y, but it can be also applied to the low side sustain switch element Q8Y, the high side recovery switch element Q9Y, the low side recovery switch element Q10Y, the first separate switch element QS1, or the second separate switch element QS2.

The first power source circuit 51 includes a first gate voltage source VG1, a charging switch element QC1, a first charging diode DC1, a first charging capacitor CC1, a comparator CP, and a resistance R.

A voltage of the first gate voltage source VG1 maintains the potential of the positive electrode higher than the potential of the negative electrode by a specific voltage VG1. The voltage of the first gate voltage source VG1 is, for example, a voltage necessary for driving the gate of the switch element such as MOSFET or IGBT (for example, 15 V). The negative electrode of the first gate voltage source VG1 is connected to the lowest voltage in the sustain period; that is, the negative electrode of the sustain voltage source Vs. The source of the charging switch element QC1 is connected to the positive electrode of the first gate voltage source VG1, and the drain of the charging switch element QC1 is connected to the anode of the first charging diode DC1. The charging switch element QC1 may preferably be a P channel element. The positive electrode of the charging capacitor CC1 is an output terminal 43 of the power source circuit 50. The negative electrode of the charging capacitor CC1 is connected to the source of the high side sustain switch element Q7Y.

The gate of the charging switch element QC1 is connected to the output terminal of the comparator CP. One end of the resistance R is connected to the positive electrode of the first gate voltage source VG1, and the other end is connected to the gate of the charging switch element QC1. The positive input terminal of the comparator CP is connected to the lowest voltage in the sustain period, that is, the negative electrode of the sustain voltage source Vs. The negative input terminal of the comparator CP is connected to the source of the high side sustain switch element Q7Y.

1.4.2 Operation of Power Source Circuit

The operation of the power source circuit shown in FIG. 5 is explained.

When the source potential of the high side sustain switch element Q7Y is lower than the potential of the negative electrode of the sustain voltage source Vs, that is, during a part of period of mode V of the reset period and the address period, the comparator CP outputs “H”, and the charging switch element QC1 is turned off. At this time, the first charging capacitor CC1 is not charged.

On the other hand, when the source potential of the high side sustain switch element Q7Y is higher than the potential of the negative electrode of the sustain voltage source Vs, that is, during modes I to IV of the reset period, a part of mode V and the sustain period, the comparator CP outputs “L”, and the charging switch element QC1 is turned on. At this time, the potential of the anode of the first charging diode DC1 becomes the potential of the positive electrode of the first gate voltage source VG1. Accordingly, when the potential of the positive electrode of the first charging capacitor CC1 is lower than the potential of the positive electrode of the first gate voltage source VG1, the first charging diode DC1 conducts to charge the first charging capacitor CC1.

In particular, the period of charging the first charging capacitor CC1 via the first charging diode DC1 is a period in which the source potential of the high side sustain switch element Q7Y is near the potential of the negative electrode of the sustain voltage source Vs. This is, it is the ON period of the low side sustain switch element Q8Y in mode I of the reset period and the sustain period.

Therefore, in the sustain period, the energy of the gate driving circuit 40 which is consumed by turning on the high side sustain switch element Q7Y can be immediately supplied every time by turning on the low side sustain switch element Q8Y. Hence, even if the capacity of the first charging capacitor CC1 is small, a stable specific voltage can be supplied to the gate of the high side sustain switch element Q7Y.

1.4.3 Other Example of Power Source Circuit

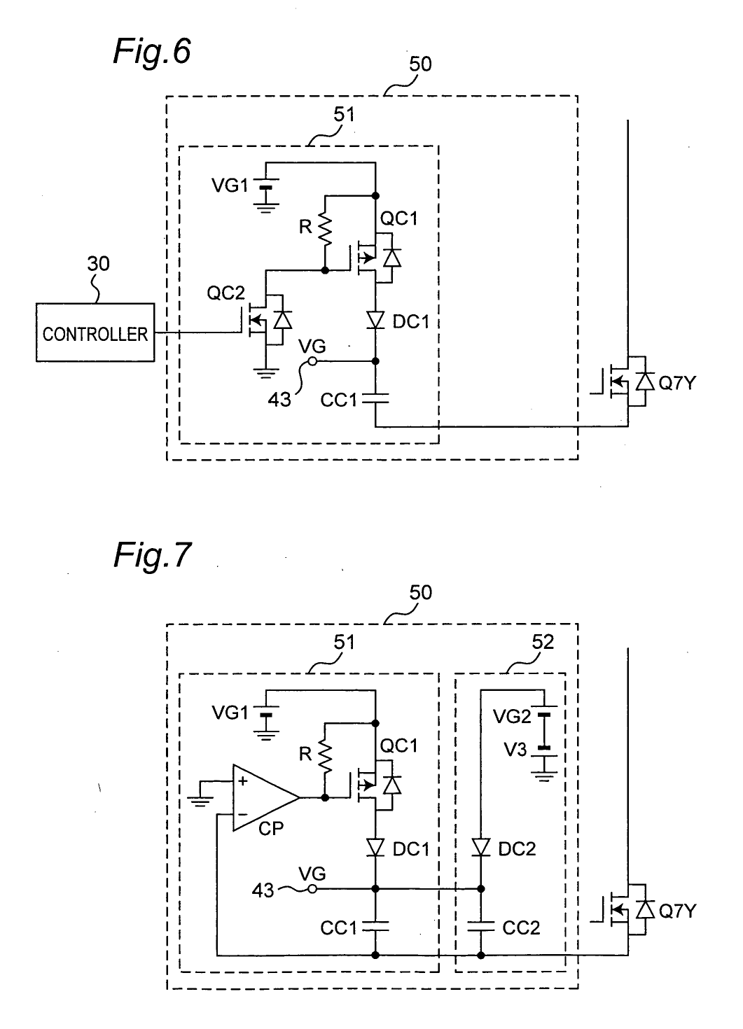

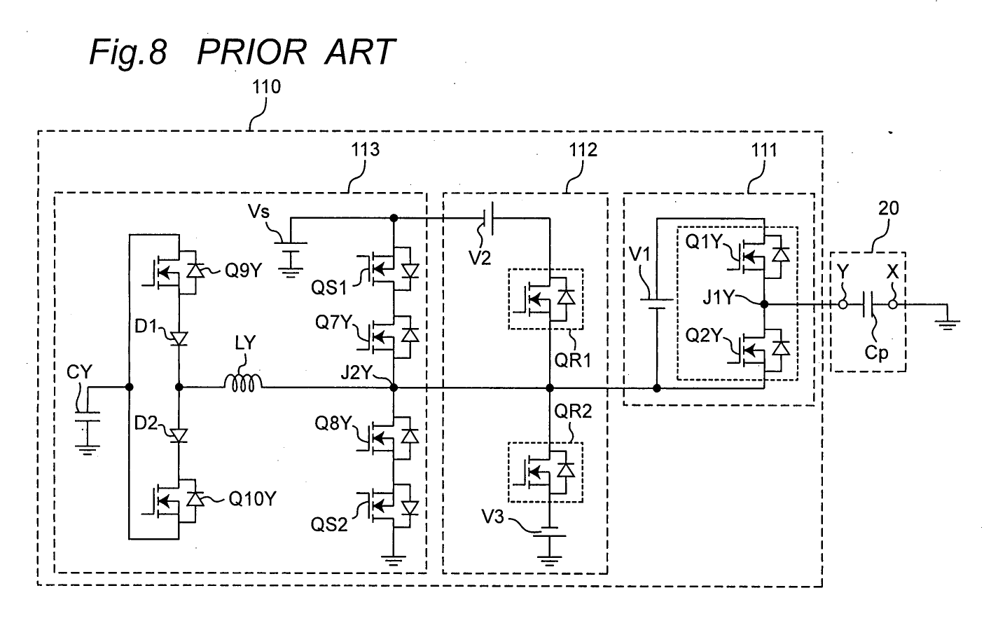

In the structure shown in FIG. 5, instead of the comparator CP, a control signal from the controller 30 and a signal switch element may be used. Such example is shown in FIG. 6. In this diagram, the signal switch element QC2 has a drain which is connected to the gate of the charging switch element QC1, a source which is grounded, and a gate which is connected to the control signal from the controller 30. When the control signal becomes “H”, the signal switch element QC2 is turned on, and the charging switch element QC1 is turned on. On the contrary, when the control signal becomes “L”, the signal switch element QC2 is turned off, and the charging switch element QC1 is turned off. Controlling the control signal allows the charging switch element QC1 to be controlled in an arbitrary period with a range in which the source potential of the high side sustain switch element Q7Y is higher than the potential of the negative electrode of the sustain voltage source Vs. This embodiment describes the example which is applied only to the scan electrode driving section. However the concept of this embodiment can also be applied to the sustain electrode driving section and the address electrode driving section.

1.5 Summary

According to the embodiment, regarding the charging capacitor for supplying the driving voltage of switch elements, the capacity of the charging capacitor can be reduced while achieving stable supply of the driving voltage to switch elements. Further, the circuit for charging the charging capacitor can be realized in a simple structure.

### Embodiment 2

The plasma display according to embodiment 2 of the invention has the same configuration as that according to embodiment 1.

FIG. 7 shows the power source circuit in embodiment 2 of the invention. The structure in the diagram is applied to the high side sustain switch element Q7Y, but it can be similarly applied to the low side sustain switch element Q8Y, the high side recovery switch element Q9Y, the low side recovery switch element Q10Y, the first separate switch element QS1, and the second separate switch element QS2.

The power source circuit 50 in this embodiment includes a second power source circuit 52 in addition to the structure in embodiment 1 shown in FIG. 5. The second power source circuit 52 includes a second gate voltage source VG2, a second charging diode DC2, and a second charging capacitor CC2.

The second gate voltage source VG2 maintains the potential of the positive electrode higher than the potential of the negative electrode by a specific voltage VG2. The voltage of the second gate voltage source VG2 is, for example, a voltage necessary for driving a gate of a switch element such as MOSFET or IGBT (for example, 15 V). The negative electrode of the second gate voltage source VG2 is connected to the lowest voltage in the reset period, address period, and sustain period, that is, the negative electrode of the third voltage source V3. The positive electrode of the second gate voltage source VG2 is connected to the anode of the second charging diode DC2, and the cathode of the second charging diode DC2 is connected to the positive electrode of the second charging capacitor CC2. The second charging capacitor CC2 is connected in parallel to the first charging capacitor CC1. That is, the positive electrode of the second charging capacitor CC2 is connected to the positive electrode of the first charging capacitor CC1, and the negative electrode of the second charging capacitor CC2 is connected to the negative electrode of the first charging capacitor CC1.

The second charging capacitor CC2 may not be provided. In such a case, the cathode of the second charging diode DC2 is connected to the positive electrode of the first charging capacitor CC1.

The operation of the power source circuit shown in FIG. 7 is explained below.

The potential of the anode of the second charging diode DC2 becomes the potential of the positive electrode of the second gate voltage source VG2. Accordingly, when the potential of the positive electrode of the second charging capacitor CC2 is lower than the potential of the positive electrode of the second gate voltage source VG2, the second charging diode DC2 conducts to charge the second charging capacitor CC2. In particular, a period of charging the second charging capacitor CC2 via the second charging diode DC2 is a period in which the source potential of the high side sustain switch element Q7Y is near the potential of the negative electrode of the third voltage source V3, and this is a part of mode V in the reset period and the address period.

The operation of the first power source circuit 51 is same as in embodiment 1. The charging period of the first charging capacitor CC1 is mode I in the reset period and the ON periods of the low side sustain switch element Q8Y in the sustain period.

Therefore, according to the power source circuit 50 of this embodiment having the first power source circuit 51 and second power source circuit 52, the first charging capacitor CC1 or second charging capacitor CC2 can be charged during mode I and a part of mode V in the reset period, the address period, and ON periods of the low side sustain switch element Q8Y in the sustain period. It is hence possible to charge in a wider period. That is, even if the capacity of the first charging capacitor CC1 and second charging capacitor CC2 is individually small, on the whole, a stable specific voltage can be supplied to gates of switching elements.

The voltage charged in mode I in the reset period by the first power source circuit 51 at start-up is consumed in mode II and mode IV. Later, the operation enters the sustain period via the address period. In the initial stage of the sustain period, since the time has passed from the charging period in mode I of the reset period, the voltage accumulated in the first charging capacitor CC1 may be possibly lowered. In this embodiment, the additional second power source circuit 52 allows the first charging capacitor CC1 to be charged even in part of mode V in the reset period and the address period. Hence, even in the initial stage of the sustain period, a sufficient voltage can be charged into the first charging capacitor CC1. According to this embodiment, therefore, a more stable specific voltage can be supplied than in embodiment 1.

### INDUSTRIAL APPLICABILITY

The invention can be applied in a driving apparatus of a plasma display. In particular, the invention improves stability of supply of the applied voltage to electrodes of the plasma display, and thus it is useful to the driving apparatus of plasma display for which a high reliability is demanded.

Although the present invention has been described in connection with specified embodiments thereof, many other modifications, corrections and applications are apparent to those skilled in the art. Therefore, the present invention is not limited by the disclosure provided herein but limited only to the scope of the appended claims.

1. A PDP driving apparatus that drives a plasma display panel having sustain electrodes, scan electrodes, and address electrodes, the PDP driving apparatus comprising:
switch elements; and
a power source circuit that generates a driving voltage of the switch elements, the power source circuit including:
a first voltage source,
a first capacitor that charges and supplies as the driving voltage, an output voltage of the first voltage source,
a charging switch element that turns on when a negative electrode of the first capacitor is at a voltage higher than a specified voltage, and
a first diode that is electrically connected to the charging switch element and charges the first capacitor with the output voltage of the first voltage source.

2. The PDP driving apparatus according to claim 1, further comprising a reset generator that includes switching elements and applies a reset voltage to the electrodes of the plasma display panel.

3. The PDP driving apparatus according to claim 1, further comprising a sustain voltage source that supplies a voltage to be applied in a sustain period for sustaining discharge of the plasma display panel, and a separate first switch element operable to cut off a current flowing to a positive electrode of the sustain voltage source.

4. The PDP driving apparatus according to claim 1, further comprising a sustain voltage source that supplies a voltage to be applied in a sustain period for sustaining discharge of the plasma display panel, and a separate second switch element operable to cut off a current flowing to a negative electrode of the sustain voltage source.

5. The PDP driving apparatus according to claim 1, wherein the power source circuit further includes a second voltage source, a second capacitor that charges and supplies as the driving voltage, an output voltage of the second voltage source, and a second diode that charges the second capacitor with the output voltage of the second voltage source.

6. The PDP driving apparatus according to claim 1, wherein the power source circuit further includes a second voltage source, and a second diode that charges the first capacitor with an output voltage of the second voltage source.

7. A plasma display comprising:
a plasma display panel having sustain electrodes, scan electrodes, and address electrodes; and
a PDP driving apparatus configured to drive the plasma display panel, the PDP driving apparatus comprising:
at least one switch element; and
a power source circuit generating a driving voltage of the at least one switch element, the power source circuit including:
a first voltage source,
a first capacitor for supplying, as the driving voltage, an output voltage of the first voltage source,
a charging switch element for turning on when a negative electrode of the first capacitor is at a voltage higher than a specified voltage, and
a first diode, electrically connected to the charging switch element, for charging the first capacitor with the output voltage of the first voltage source.

8. The plasma display according to claim 7, wherein the PDP driving apparatus further comprises a reset generator that includes switching elements and applies a reset voltage to the electrodes of the plasma display panel.

9. The plasma display according to claim 7, wherein the PDP driving apparatus further comprises a sustain voltage source that supplies a voltage to be applied in a sustain period for sustaining discharge of the plasma display panel, and separate first switch element operable to cut off a current flowing to a positive electrode of the sustain voltage source.

10. The plasma display according to claim 7, wherein the PDP driving apparatus further comprises a sustain voltage source that supplies a voltage to be applied in a sustain period for sustaining discharge of the plasma display panel, and a separate second switch element operable to cut off a current flowing from a negative electrode of the sustain voltage source.

11. The plasma display according to claim 7, wherein, in the PDP driving apparatus, the power source circuit further includes a second voltage source, a second capacitor that charges and supplies as the driving voltage an output voltage of the second voltage source, and a second diode that charges the second capacitor with the output voltage of the second voltage source.

12. The plasma display according to claim 7, wherein, in the PDP driving apparatus, the power source circuit further includes a second voltage source, and a second diode that charges the first capacitor with an output voltage of the second voltage source.
